(19) United States
(12) Patent Application Publication
(10) Pub. No.: US 2004/0111818 A1
(43) Pub. Date: Jun. 17, 2004

(54) Advanced paint rollers and connecting method

(76) Inventor: Erjian Ma, Norcross, GA (US)

Correspondence Address: ERJIAN MA, 11175 THAMES LANE, SUWANEE, GA, 30024, US

(21) Appl. No.: 10/318,036

(22) Filed: Dec. 13, 2002

(51) Int. Cl. B05C 17/02

(52) U.S. Cl. 15/230.11; 15/230.18; 492/13; 492/19; 15/257.06

(57) ABSTRACT

A painting device, which is used for painting a plurality surfaces including curvature surfaces is invented. The painting devices have various shaped paint rollers that comprising the cone-shaped, V-shaped, I-shaped, wave-shaped, trapezoid-shaped, protrude-shaped, waist-drum-shaped and etc. These shaped rollers can be used singularly or by joining two or more together to form another shaped roller. Furthermore, the covered area of the roller can be changed by varying the length of the shaped rollers and the working surfaces of some of the rollers are covered by a flexible material that allows the length to be changed. These joined surfaces (corners), round rods, rectangular beams and other such structures can be finished efficiently with these rollers, respectively. The advantages of these paint rollers are painting complex structures that have multiple surfaces or various curvature surfaces with one stroke. Therefore, using the paint roller can provide a significant times savings with a high quality finish to complete the painting work. By the way, the paint rollers are suitable for automatic-driven roller. And a corresponding paint tray is introduced also.

### BACKGROUND

1. Field of Invention

The present invention is related to a paint device and method of using, more specifically, a paint roller, which is a solid body of revolution. The solid body has different shapes, changeable or combinable shapes, which are designed based on object to be painted.

2. Description of Prior Art

A commonly used manual painting device compared with an automatic painting device has its own advantages: easy to clean, easy to change roller body and its price is much lower. The manual paint device has a very simple structure typically, it is comprised of a handle, a cage assembly, a support shaft and a roller. The paint roller is the most important part.

In the market, generally, a paint roller always is made like a cylinder body. Stated geometrically, a cylinder is generated by revolving a straight line around the centerline, so this kind of roller can be called a Straight Rotational Roller.

A Straight Rotational Roller could be made of variety of lengths and diameters if necessary. However, this kind of roller is good enough used for painting an plane object, a large area such as a wall, but a practiced person should know the hardest part of the work of painting is painting complex structures, corners, either convex or concave corners. For example, to paint a doorframe, a window frame, or a fence, the most time is spent painting corners or bar/stile structures. When complex structures are to be painted, the Straight Rotational Roller is awkward to use because these rollers are designed to be used on a plane surface, and is unable to touch the corners, or curvature surfaces.

There before, inventors here created many inventions related to the manual painting device, but most of the inventions are focused on how to clean the paint roller, redesign the roller cage, improve the cloth materials that cover the paint roller, how to elongate the extension rod, and such as. There are only a few Design Patents, which are related to the paint roller, for example, in USA, U.S. Pat. No. D392,102 to Snetting Mark E., et al (1998) gave a new handle design, U.S. Pat. Nos. D268,228 (1983), D268,229 (1983), D268,230 (1983), D268,231 (1983), D269,924 (1983), D287,314 (1986), D287,431 (1986) etc. all to Hori, U.S. Pat. No. D336,371 to Harris (1993) and U.S. Pat. No. D403,866 to Lapre (1999) etc. Although some of the Design Patents related to paint the corners but these paint rollers are limited by a certain angle or by certain shapes on their designs.

Summarizing all the paint roller designs heretofore known suffer from a number of disadvantages:

(a) The paint rollers are designed as a cylinder, this kind of roller is not convenient to be used for painting a complex object.

(b) An engraved surface on a roller could influence the distribution of painting materials or impacting on a painted pattern upon an object, could not be used for delivering a paint material upon a complex surface.

(c) Some designs could be used for painting a corner, but only for certain angles and a certain shape.

(d) These rollers cannot be used for painting two or more surfaces simultaneously.

(e) These kinds of rollers are not for painting a small-cubed structures such as a round rod or V-shaped beam or any other structures that have a constant cross-section.

(f) These rollers are not for painting a curvature surface.

(g) These roller shapes are unable to be changed or to be combined in order to form other kinds of roller shape.

(h) There is no method to change the roller's shape

(i) There is no method to connect two or more rollers together.

### SUMMARY

The present invention introduces a paint roller that has an axial rotational body, which is generated by revolving a series of connected straight lines or arc lines instead of one straight line, so the body can be called a Curvature Rotational Roller. A complex object, or surface that has many corners or curvature surfaces could be painted efficiently by using a Curvature Rotational Roller.

Depending on the objects to be painted, there a variety of Curvature Rotational Rollers, which are named as the Advanced Paint Roller in the present patent.

In accordance with the present invention an advanced paint device provides advanced paint roller, a materials carrier, to transfer a coating material upon surfaces of a complex object. The advanced paint rollers have axial-rotational body, which is generated by revolving a series of straight lines or arc lines around a centerline. Furthermore, the advanced paint roller can be combined with a plurality of axial-rotational rollers and can be flexible in fabrication.

### OBJECTS AND ADVANTAGES

It is an objective of the present invention to provide an advanced paint device and its combination method in order to finish complex paintwork efficiently.

Accordingly, besides the objects and advantages of the advanced paint roller in the present patent, several objects and advantages are list as following:

(a) To provide paint rollers, which can be used for painting both sides of surfaces, which are along a corner;

(b) To provide paint rollers, which can be used for painting an object, which has multiple plane surfaces and/or curvature surfaces synchronously, conveniently and qualitatively;

(c) To provide a method, which is used to combine two or more paint rollers together to form a new paint roller; even the same rollers can form another roller by rearrangement of the roller mounting direction.

(d) To provide a mechanism, which is used for changing final shapes of paint roller by relocating their parts.

The priority objects and advantages are to provide the paint rollers, which can be use for finishing paintwork conveniently with high quality and result in significant time saved. Furthermore, these paint rollers are the axial-rotational body, which can be manufactured simply with a low cost through mass production.

### DRAWING FIGURES

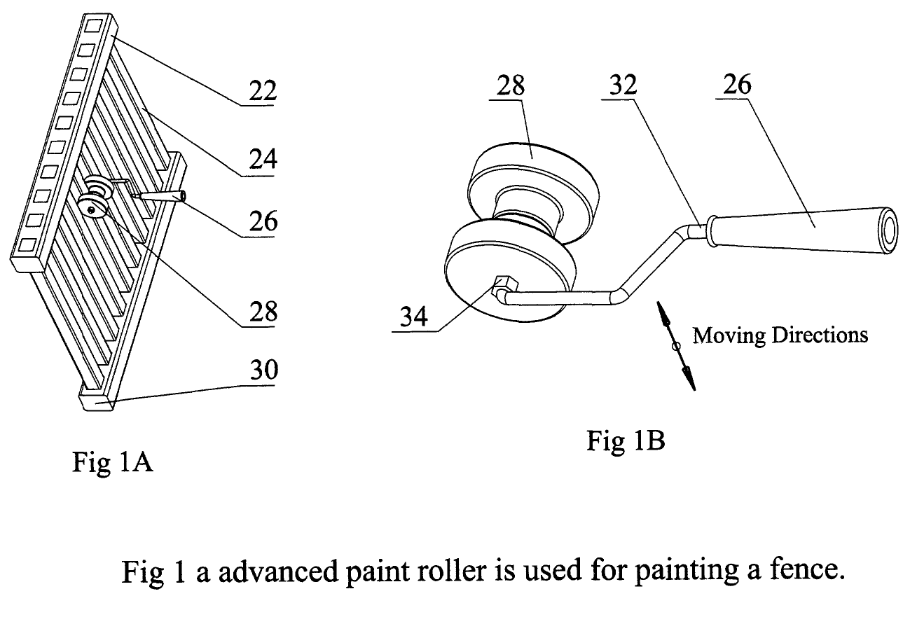

1. FIGS. 1 show an advanced paint roller used for painting a fence.

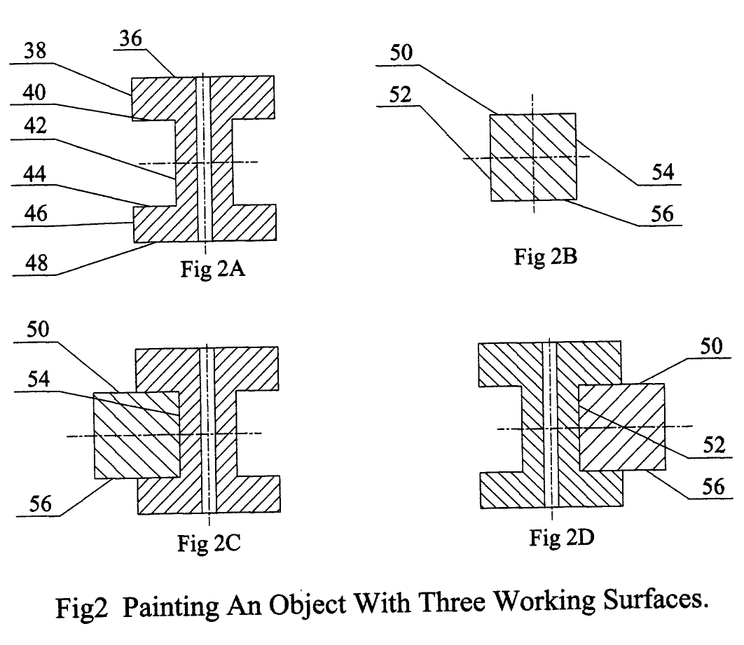

2. FIGS. 2 show painting an object with three working surfaces.

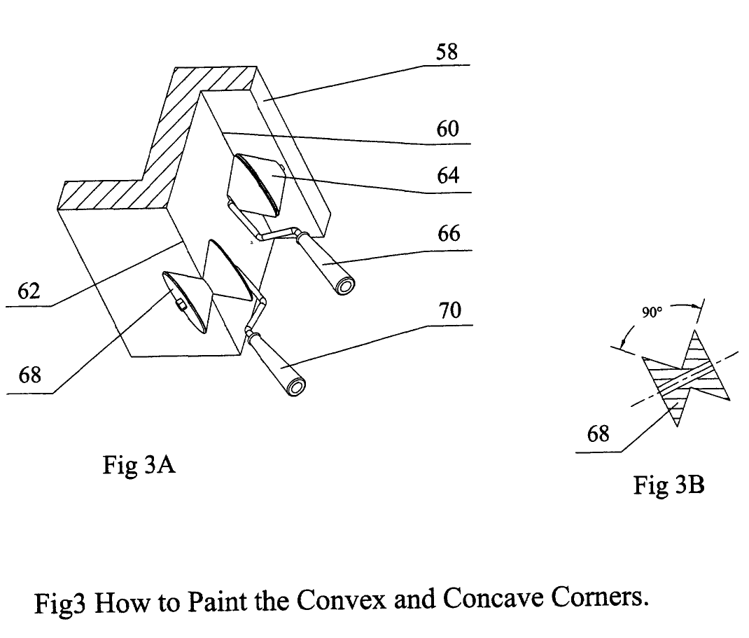

3. FIGS. 3 show how to paint the convex or concave corners.

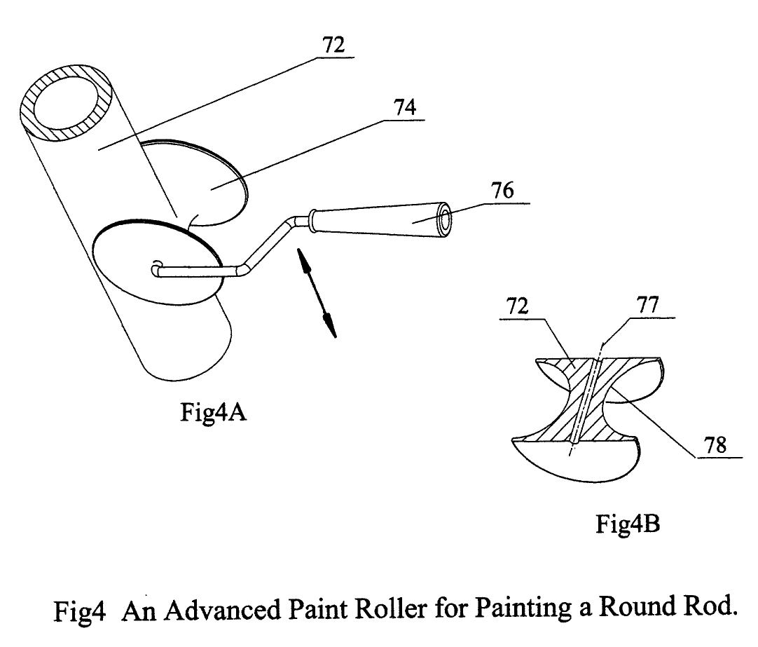

4. FIG. 4 shows an advanced paint roller for painting a round rod.

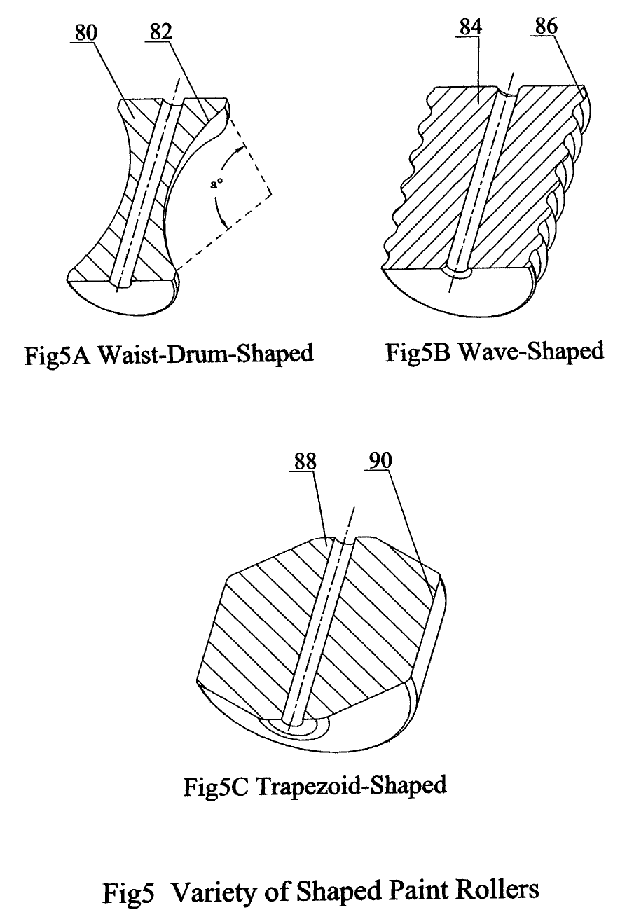

5. FIGS. 5 show a variety of different shaped paint rollers.

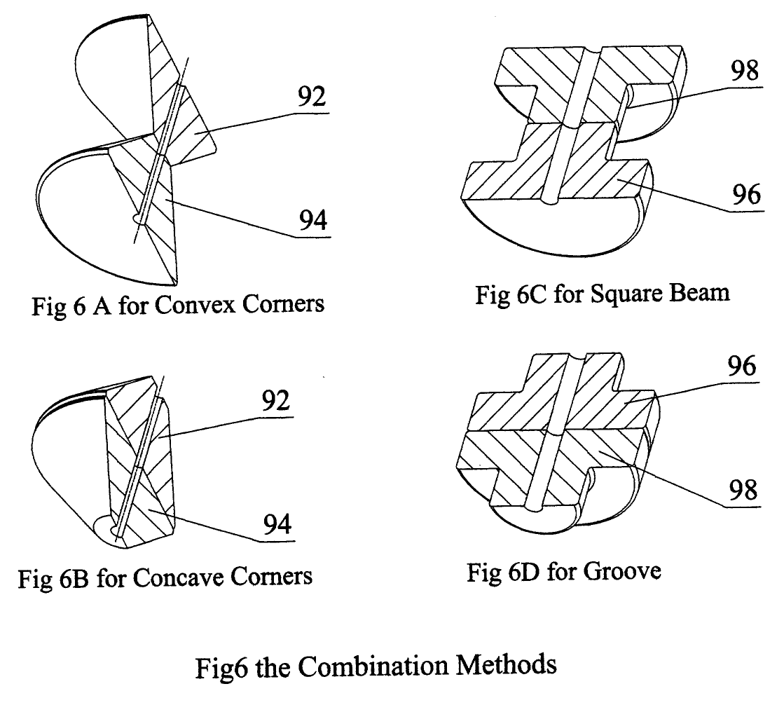

6. FIGS. 6 show the combination methods.

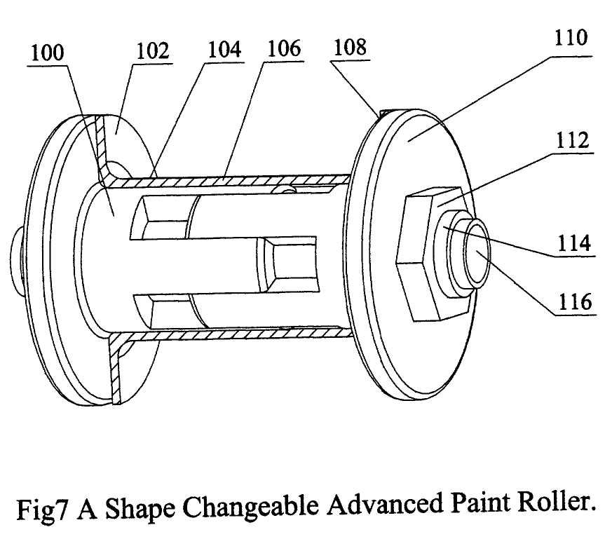

7. FIG. 7 shows a shape changeable advanced paint roller.

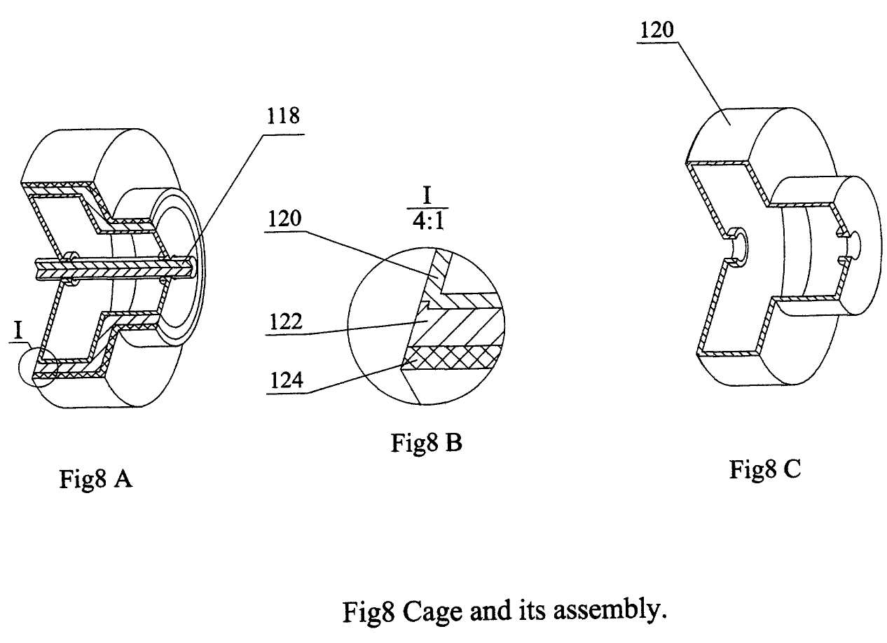

8. FIGS. 8 show a cage assembly structure.

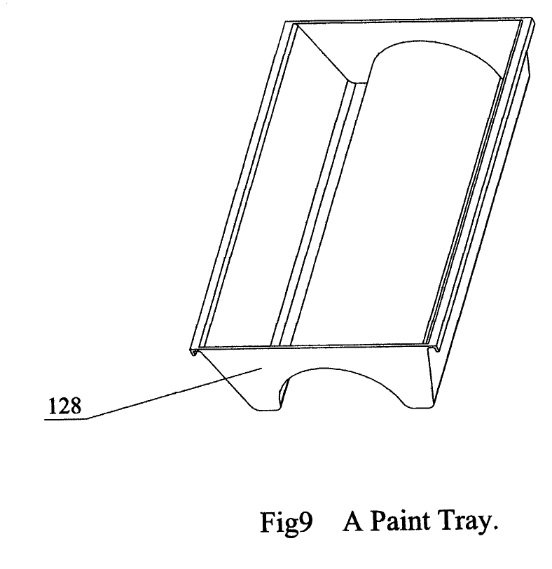

9. FIG. 9 shows a tray design.

### REFERENCE NUMERALS IN DRAWINGS

| | |
|---|---|
| 22 horizontal rod of a fence | 24 vertical rod of the fence |
| 26 the handle of a paint device | 28 a roller of paint device |
| 30 horizontal rod the fence | 32 roller shaft of paint device |
| 34 position nut of paint device | 36, 38, 40, 42, 44, 46 and 48 |
| | straight-edge-lines |
| 50, 52, 54, and 56 surfaces of rod 24 | 58 a typical structure |
| 60 a concave corner | 62 convex corner |
| 64 advanced paint roller | 66 a handle |
| 68 another roller | 70 a handle |
| 72 a rod | 74 a roller |
| 76 a handle | 77 an axis line |
| 78 a half circle line | 80 an advanced paint roller |
| 82 an arc line | 84 an advanced paint roller |
| 86 a wave line | 88 an advanced paint roller |
| 90 a trapezoid shape | 92 and 94 half-pieces of roller |
| 96 and 98 half-pieces of roller | 100 half-roller |
| 102, 104 working surfaces of the roller | 106 cloth |
| 108 working surface of the roller | 110 half-roller |
| 112 a locking nut | 114 a screwing tube shaft |
| 116 a shaft | 118 an axial shaft |
| 120 a cage | 122 roller body |
| 124 a cloth | 126 a tray |

### DETAIL DESCRIPTION OF THE INVENTION

In the following section, how to design the advanced paint roller and how the advanced roller works will be given in more details. Just as briefly described above, a advanced paint roller has one or more axial-rotational bodies and the rotational body can be designed having different sizes and geometrical shapes, and two more the axial rotational bodies can be mounted together to form another advanced paint roller.

### Description—Main Embodiments

There are many embodiments to presented the invention and only several examples are introduced here.

### Embodiment 1

FIGS. 1 schematically show an advanced paint roller that is used for painting a fence. In FIG. 1A, the fence has horizontal rods 22, 30 and one vertical rod 24, which has a square shaped cross-section. As an example, the rod 24 can be painted as described in following.

The FIG. 1B shows an enlarged drawing of an advanced paint device. The paint device has a roller 28, a handle 26, a roller shaft 32 and a position nut 34. The paint roller 28 is designed for painting the rod 24. The square rod 24 is inserted into the roller 28, and when roller 28 is moved along the vertical direction, see the arrows in FIG. 1B, three surfaces of rod 24 can be painted.

FIG. 2A shows a cross-section of roller 28 through its axis. A half cross-section has straight edge-lines 36, 38, 40, 42, 44, 46 and 48. In this design, the edge-lines 40, 42, and 44 are the working edges, which indicate three working surfaces to touch three surfaces of rod 24, respectively. Only the paint application surfaces are covered by a special cloth, which is designed for absorbing and carrying paint.

FIG. 2B shows a square shape cross-section of rod 24. The square has four lines 50, 52, 54, and 56 represent four surfaces of the rod 24, respectively. The roller's edge-lines 40, 42 and 44 are designed for touching the three surfaces 50, 54, and 56, respectively, see FIG. 2C. When the roller 28 is rolled along the axial direction of rod 24, three surfaces of the rod will be painted simultaneously. The remaining surface 52 and its adjacent two surfaces can be done by the same way, see FIG. 2D.

### Embodiment 2

FIG. 3A shows a typical structure 58, which has a concave corner 60 and convex corner 62 the window, the door, and any wall usually have such structure. An advanced paint roller 64 with a handle 66 is designed for painting concave corner 60, and the other roller 68 with its handle 70 is designed for painting convex corner 62. Obviously, the areas in both sides along the corners can be painted simultaneously with a high painting quality.

In most structure, any adjacent two surfaces should be perpendicular to each other, a roller designed with a 90° angle can be employed to paint such structures, see FIG. 3B. Of course, a paint roller can be designed with any angle to match a certain object.

### Embodiment 3

FIG. 4A shows a rod 72 has a round shaped cross section. An advanced paint device has a roller 74 and a handle 76. The roller 74 has an axis line 77 and is designed for painting the round rod 77. The paint roller has axial-rotational body that is generated by revolving a half circle line 78 around centerline 77, see FIG. 4B. Additionally, the diameter of arc line 78 is equal to outside diameter of rod 72, so the roller 74 is matches the rod 72 and covers half of the surface of the rod 72 with each paint stroke. When the roller 77 is moved along the vertical direction, see the arrow shown in FIG. 4A, the entirety of rod 72 can be finished with two painting passes theoretically, therefore, using the advanced paint roller can have a significant time saving advantage.

### Embodiment 4

Actually, the advanced paint roller can be designed for painting any typical and commonly used structure correspondingly. FIGS. 5 show three more examples.

FIG. 5A shows an advanced paint roller 80 is generated by revolving an arc line 82. The arc line 82 covers a central angle α is less than 180°, that means the arc line 82 is only a partial half circle. The roller 82 is designed for painting a large round rod.

In FIG. 5B, an advanced paint roller 84 is generated by revolving a wave line 86. This kind of roller is used to paint a wavy panel structure.

Another example is shown in FIG. 5C. An advanced paint roller 88 is generated by the revolutions a trapezoid shape 90. This kind of roller is designed for painting the inside surface of a U-bar (U-Steel).

### Ramification of Embodiments

The advanced paint roller could be questioned about “universalization”. There are many style structures and there is a series dimensions for each of the styles. Do we need to design many advanced paint rollers for each structure and dimension? Is it possible and necessary?

Actually, the typical structure is limited to several styles: the round rod, the rectangular beam, hexagon beam, and others. In the market, every structure style and its dimensions are standardized, there are not random numbers. For each structure, their dimension is made of a series of numbers, something like ½″, 1″, 2″, 4″ and so on. The advanced paint rollers are only designed and coincided with the dimension series.

In addition, in the market, many styles and dimensions of paint rollers may be needed, but as customers, to paint a certain paintwork, the style and its dimensions are determined before they go to a hardware store to buy an advanced paint roller, therefore, they only need to pick the paint roller that is a match to their painting task. Something like, there are many styles and dimensions nut and screw in the hardware store, but a customer only need to select their needed things.

Anyway, the advanced paint roller can be made more flexible. In the next embodiments, several designs and methods are introduced to solve the problem of the universalization, to make the advanced paint roller flexible and more useful.

### Ramification of Embodiment 1

In order to avoid too many styles and dimensions being manufactured for the advanced paint roller, a paint roller can be formed with different paint roller combinations. FIGS. 6 show a paint rollers combination methods. Other parts of the painting device are not show here.

In FIG. 6A, an advanced paint roller, which is designed for painting convex corners is combined with two half-piece rollers 92 and 94 when the concave corners are needed to be painted, another paint roller can be made by using the same pieces of rollers 92 and 94 but with different orientation, see FIG. 6B.

By the same mechanism, an advanced paint roller could be used for painting a square beam as well as for painting a square shape groove, See FIG. 6C. An advanced paint roller comprised of two half-piece rollers 96 and 98. It could be used for painting outside surface of a square rod. But, see FIG. 6D, using the same two half pieces rollers but different mounting direction, another advanced roller can be formed. This roller could be used for painting inside surfaces of a square groove.

The connecting method can be used to join two or more straight rollers, which are the generally used paint rollers, along their axial direction in order to extend a length of the roller. The longer roller can cover wider area and make the painting work efficient. When a large plane area, a wall, this connected roller is more useful.

### Ramification of Embodiment 2

An advanced paint device and an adjustment mechanism are shown in FIG. 7. The advanced paint roller is proposed to paint multiple surfaces with one paint roller. Besides, one style paint roller can be used for painting the object with different dimensions object. This design can make the advanced paint roller more flexible and useful.

In the schematic drawing, an advanced paint roller is designed for painting a rectangular beam, which is the widest used structure. Said beam, and other parts of the paint device are not shown in FIG. 7.

The paint roller has three working surfaces 102, 104 and 108 that are used to paint three surfaces of the beam at the same time. The roller is separated into two half-rollers 100 and 110 and assembled on a screwing tube shaft 114. A cloth 106 (only a half cross section is shown in FIG. 7) covers the two half-rollers. In order to allow the two half-rollers free moving along their axis, the cloth 106 is only attached to each end of the half-roller, not attached to their middle area.

The opposite screw thread is made on each end of the shaft 114. One end is right rotation and the other end is left rotation thread, and the two half-rollers 100 and 110 are screwed on each end of shaft 144, respectively. When the shaft 114 is rotated, the two half-rollers could be adjusted to be larger or smaller, resulting in a distance between the two half-rollers that coincides with the beam's dimension. Once, the half-rollers are adjusted to appropriate positions, a locking nut 112 can lock the rollers at their positions. A shaft 116 is connect to handle and allows the roller rotating around it.

### Ramification Embodiment 3

Look at inside structure of the advanced paint rollers. An advanced paint roller can be simply made as a solid structure with a axial hole. But, a larger roller is designed as a hollow structure. The hollow roller is fixed on a cage assembly. This structure results in reducing the roller's weight and allows for ease of changing the roller.

FIGS. 8 schematically show a paint roller that is designed for painting a rectangular beam with a cage structure. FIG. 8A is an assembly drawing. FIG. 8B is a partially enlarged drawing. FIG. 8c shows the cage assembly.

In FIG. 8A, an axial shaft 118 connect the roller to a handle; a cage 120 is fixed on shaft 118 and allowed to rotate around 118; roller body 122, made of plastic materials, is the main part of the painting device; a cloth 124, made of a paint absorber, covers the roller body 122. In general, the 122 and 124 is made into one part, and mounted on the cage, see FIG. 8B. The cage 120 is made of sheet metal, its outside shape just like roller body's shape.

### Ramification Embodiment 4

A tray contains paint, when a paint roller is rolled in the tray, the paint will be liberally applied to the rollers surface, and any excess paint can be squeezed out.

FIG. 9 shows a tray 126 that is designed for supplying paint material for an advanced paint roller, which is used to paint a round rod.

What is claimed is:

1. An article of paint roller device is named as Advanced Paint Roller to accommodate use for transfer fluid or fine powder materials upon surfaces of an object in order to coat the surfaces, comprising:
a. at least one axial-rotational body roller,
b. a cage assembly to support said axial-rotational body roller,
c. a handle assembly for holding and operating said device,
d. an elongated support member is assembled into an axis of said axial-rotational body roller by a means in order to support said axial-rotational body roller.
e. a cloth covers said axial-rotational body rollers by a implantation means,
f. said support member allows said axial-rotational body roller to rotate around its axis by a driving means,
g. said support member allows changing a distance between said axial-rotational body rollers by a positing means,
h. aid support member allows changing a assembly direction of said axial-rotational body roller by a mounting method,
i. a means for joining said elongated support member to said handle.
j. an elongation method for extending a general straight paint roller,
k. a tray for containing said fluid and/or fine powder materials and said axial-rotational body roller can acquire said material from said tray properly.

2. The advanced paint roller of claim 1 within said axial-rotational body roller has a variety of generatrix.

3. The advanced paint roller of claim 2 within said generatrix comprising a plurality of straight lines and/or arc lines and these lines joined together at proper angles in order to build a certain geometric shapes with the straight edges and/or arc edges, respectively.

4. The advanced paint roller of claim 3 within said certain geometrical shape is coincided with a certain structure to be painted.

5. The advanced paint roller of claim 3 within said the certain geometrical shape comprising convex corner shapes and/or concave corner shapes.

6. The advanced paint roller of claim 1 within said driving means to rotate said axial-rotational body roller with either a manual and/or automatic driver.

7. The advanced paint roller of claim 1 within said positing means to change a distance between said axial-rotational body rollers with is a screw-driven mechanism.

8. The advanced paint roller of claim 1 within said cover cloth is a substantially thicker and flexible material.

9. The advanced paint roller of claim 1 where as said mounting method for changing the assembly direction such that it result in the roller body orientation of at least two advanced paint rollers being changed to result in a different shape of said roller body.

10. The advanced paint roller of claim 9 within said orientation methods connects plurality of advanced paint rollers together in different directions, in order to change the overall shape of an advanced paint roller.

11. The advanced paint roller of claim 1 within said elongation method is joining at least two general straight paint rollers together along their axial direction in order to extend the paint roller.

12. The advanced paint roller of claim 1 within said cage assembly is a thin wall structure,

13. The advanced paint roller of claim 12 within said thin wall structure is designed in a certain shape, which is matched to said paint roller shape.

14. The advanced paint roller of claim 1 within said tray is designed with a specific tray shape supply paint materials for the advanced paint roller.

15. The advanced paint roller of claim 13 within said specific tray shapes are groove shapes, is matched to specific advanced paint roller shapes, respectively.
